(19) United States
(12) Patent Application Publication
(10) Pub. No.: US 2017/0060348 A1
(43) Pub. Date: Mar. 2, 2017

(54) COMPACT DISPLAY OF HIERARCHICAL STRUCTURE ON USER INTERFACE

(71) Applicant: SAP SE, Walldorf (DE)

(72) Inventor: Aparna Kongot, Bengaluru (IN)

(21) Appl. No.: 14/836,393

(22) Filed: Aug. 26, 2015

(51) Int. Cl. G06F 3/0481; G06T 11/20; G06F 3/0484; G06F 3/0485; G06T 11/00; G06T 3/40

(52) U.S. Cl. CPC G06F 3/0481; G06T 11/001; G06T 3/40; G06F 3/04842; G06F 3/04847; G06F 3/0485; G06T 11/206

(57) ABSTRACT

A computer-implemented method includes rendering a graphical overview representing all of a hierarchical structure in a single overview display panel or window on a computer screen. Each node of the hierarchical structure is visually represented as a cell or mark in the graphical overview. The method involves scaling the sizes of the cells or marks so that the graphical overview representation of all of the hierarchical structure fits in the single overview display panel or window of the computer screen.

### BACKGROUND

Hierarchical structures or process flows (e.g., manufacturing or assembly line process flows) can be visually displayed on computer user interfaces, for example, as tree diagrams with multiple branches and nodes representing the process flows. A large hierarchical structure or process flow can have a correspondingly large number of nodes and hierarchical levels (e.g., branch levels). Such a large hierarchical structure or process flow may be visually depicted on the computer user interfaces as a correspondingly large tree diagram or process flow diagram that extends over several pages of display (e.g. when using legible-text size cells, marks or symbols to represent the nodes). Each single display page may show only a portion of the large tree diagram or process flow diagram. A particular node, branch or portion of the large tree diagram or process flow diagram may be displayed on a specific one of the multiple pages of display. A user who may be interested in inspecting the particular node, branch or portion of the large tree diagram or process flow diagram may have to scroll through or drill down through the multiple pages of display (e.g., with multiple clicks), or perform other actions (e.g., a search) to navigate through the multiple pages of display and locate the particular node, branch or portion of interest and the specific page on which the particular node, branch or portion of interest is displayed. In the process of scrolling through or drilling down to the particular node, branch or portion of interest, the user's view of tree diagram or process flow is fragmented, limited, or narrowed (e.g., to a view of only the specific page on which the particular node of interest is displayed). The user may no longer have a visual view of where the particular node is located in the overall tree diagram or structure. Contextual information, for example, the context of the entire structure of the tree diagram or process flow relative to the particular node, branch or portion of interest is lost.

### SUMMARY SECTION

In a general aspect a computer-implemented method involves rendering a graphical overview representing all of a hierarchical structure (or tree diagram) in a single overview display panel on a computer screen. Each node of the hierarchical structure is visually represented as a cell in the graphical overview. When the graphical overview is larger in size than the single overview display panel (e.g., when the cells representing the nodes have sizes equal or larger than a legible-text size) , the method includes scaling down the sizes of the cells so that the graphical overview representation of all of the hierarchical structure fits in the single overview display panel on the computer screen.

The details of one or more implementations are set forth in the accompanying drawings and the description below. Further features of the disclosed subject matter, its nature and various advantages will be more apparent from the accompanying drawings, the following detailed description, and the appended claims.

### BRIEF DESCRIPTION OF THE DRAWINGS

FIG. 1 is a schematic block diagram illustration of an example system, which includes a business application with a frontend user interface having process flow visualization capabilities, in accordance with the principles of the present disclosure.

FIG. 2 is a schematic illustration of an example computer screen including an overview panel, which displays an overview (i.e. a compact yet complete view) of a hierarchical structure, in accordance with the principles of the present disclosure.

FIG. 3 is a schematic illustration of an example computer screen which includes a hierarchical structure overview displayed in a single tree diagram overview panel, and a multi-page display panel, which shows an exploded or expanded view of a portion of the hierarchical structure, in accordance with the principles of the present disclosure.

FIG. 4 is an illustration of an example method for visually conveying information on a large tree diagram or a hierarchical structure to a viewer, in accordance with the principles of the present disclosure.

### DETAILED DESCRIPTION

Process flow modeling may be used to graphically describe various processes (e.g., work flow units or tasks) that may occur in an organization, business, or industry. A process hierarchy may be necessary to divide a complex or large process into smaller parts. The process hierarchy may divide the process on different levels of granularity and include information on specific process steps and their logical order. The process hierarchy may be defined by its levels and the information given in these levels. The process hierarchy may be graphically represented by a tree diagram.

For convenience in description, the terms “process flow,” “hierarchical structure,” “process flow hierarchy” and “tree diagram” may be used interchangeably herein.

An interactive graphical representation of a process flow, which may be dynamic, may be displayed on a computer user interface. A user can, for example, focus on, explore, investigate, monitor, intervene, or study individual process steps at different levels of the process flow hierarchy displayed on the computer user interface. A unified or overall view of the process flow at one or more levels of the process flow hierarchy may beneficially provide perspective and contextual information even as information on individual process steps at different levels of the process flow hierarchy is displayed to a user.

Systems and methods for presenting a compact yet complete visual view (“overview”) of an entire portion or a large portion of a hierarchical structure or process flow are described herein, in accordance with the principles of the present disclosure. The compact visual view of the entire or a large portion of a hierarchical structure or process flow may be configured to be visually displayed in a single display panel or window (“overview display panel”) of a computer screen. Visual user interface control elements (“visual UI elements”) may be integrated in the overview displayed on the computer screen. The visual UI elements may be configured so that a user can interact with the displayed overview to focus on, explore, investigate, monitor, or study individual process steps at different levels of the process flow hierarchy, even while the overview display panel remains displayed of the computer screen.

A software application (e.g., a business application, a work flow management application, etc.) may be programmed or coded to present the compact visual view (“overview”) of the entire portion or a large portion of a hierarchical process flow structure on an interactive frontend interface of the application. The software application may, for example, be configured to dynamically monitor or manage the hierarchical process flow (e.g., a product manufacturing process flow). The software application may include a rendering engine configured to display an overview of the entire portion or a large portion of the hierarchical process flow on the interactive frontend interface in a single overview display panel.

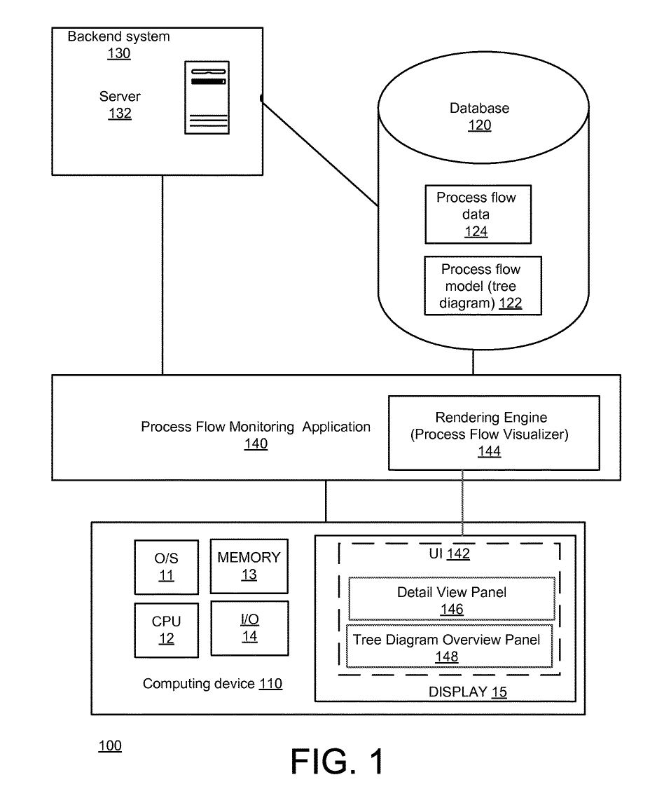

FIG. 1 is a schematic block diagram showing an example system 100 including a software application (e.g., process flow monitoring application 140) configured to present a compact visual view (“overview”) of the entire or a large portion of a hierarchical structure or process flow on a frontend user interface (e.g., UI 142) in a single overview display panel (e.g., tree diagram overview panel 148), in accordance with the principles of the present disclosure.

In system 100, process flow monitoring application 140 may be coupled to one or more databases (e.g., a business database 120). Business database 120 may, for example, include data defining a hierarchical process model or tree diagram (e.g., process flow model 122) of a process flow. The process flow may, for example, relate to a manufacturing process for making a product (e.g., an automobile, or a semiconductor device) or a business process for providing a service (e.g., shipping, transportation, or warehousing service). The nodes of the process flow may, for example, correspond to different workstations or branch points in the manufacturing or business process. The process flow may have a large number of nodes and or hierarchical levels. Business database 120 may further include, or dynamically accumulate. process flow information (e.g., process flow data 124) related to various process steps or nodes in the process flow. The process flow information may include current, historical, and/or predicted process flow information (e.g., status, work units in progress, backlog, completion information, etc.) related to various process steps or nodes in the process flow.

In an illustrative example implementation of system 100, process flow monitoring application 140 may, for example, be hosted or launched on a computer 110. Computer 110, which includes an O/S 11, a CPU 12, a memory 13, and I/O 14, may further include a user interface or display screen (e.g., display 15). Although computer 110 is illustrated in the example of FIG. 1 as a single computer, it may be understood that computer 110 may represent two or more computers in communication with one another. Therefore, it will also be appreciated that any two or more components 120-148 of system 100 may similarly be executed using some or all of the two or more computers in communication with one another. Conversely, it also may be appreciated that various components illustrated as being external to computer 110 may actually be implemented therewith. In an example scenario, process flow monitoring application 140 may be an application, which can run on computer 110 or, for example, in another computing environment (e.g., backend system 130/server 132).

Process flow monitoring application 140 may include a process flow visualizer (e.g., rendering engine 144), which is configured to visually display graphical representations (including, for example, overviews) of the process flow. Rendering engine (e.g., process flow visualizer 144) may be configured to visually display information associated with the process flow on an interactive frontend (e.g., UI 142) of the application. UI 142 may, for example, be constructed using standard components (e.g., generic user interface building blocks (UIBBs)) and/or custom-developed components for UI display entities (e.g., graphics, charts, lists, forms, trees, etc.), which can be used to display data.

The information displayed on UI 142 by the rendering engine 144 may, for example, include details of, or other information associated with, specific nodes or hierarchy levels (or portions or segments thereof) of the process flow. Such information may be displayed, for example, in a window or panel (e.g., detail view panel 146) on UI 142.

Rendering engine 144 may be further configured to display an overview of a large portion of the process flow in a single overview display panel (e.g., tree diagram overview panel 148) on UI 142, in accordance with the principles of the present disclosure.

Tree diagram overview panel 148 may include a visual graphical or a tree diagram representation of the large portion of the process flow as the overview. Tree diagram overview panel 148 may displayed in addition to, or as an alternate to, a “detail view” panel 146 on UI 142. The visual graphical or a tree diagram representation of the large portion of the process flow may include user-activable interactive UI elements (e.g., links or visual UI elements) representing, for example, the nodes, branches, and hierarchy levels (or portions thereof) of the process flow. Using these interactive UI elements, a viewer may interact with the overview to focus on, explore, investigate, monitor, or study individual process steps at different levels of the process flow hierarchy, even while the overview remains displayed in overview display panel 148 remains of the computer screen. When the viewer activates (e.g., by clicking on or pointing to) a link or visual UI element, rendering engine 144 may display information related to the corresponding node, branch, hierarchy level of the process flow, for example, in detail view panel 146 (or other pop-up window), even while tree diagram overview panel 148 remains on display. The simultaneous or concurrent visual display of the overview in tree diagram overview panel 148 may provide perspective and context to information relating to corresponding nodes, branches, hierarchy levels displayed in detail view panel 146.

An example hierarchical tree diagram may, for example, represent a process flow (e.g., an automobile manufacturing or assembly line process flow) with tree diagram nodes corresponding to various process steps and/or process work stations in the automobile manufacturing process.

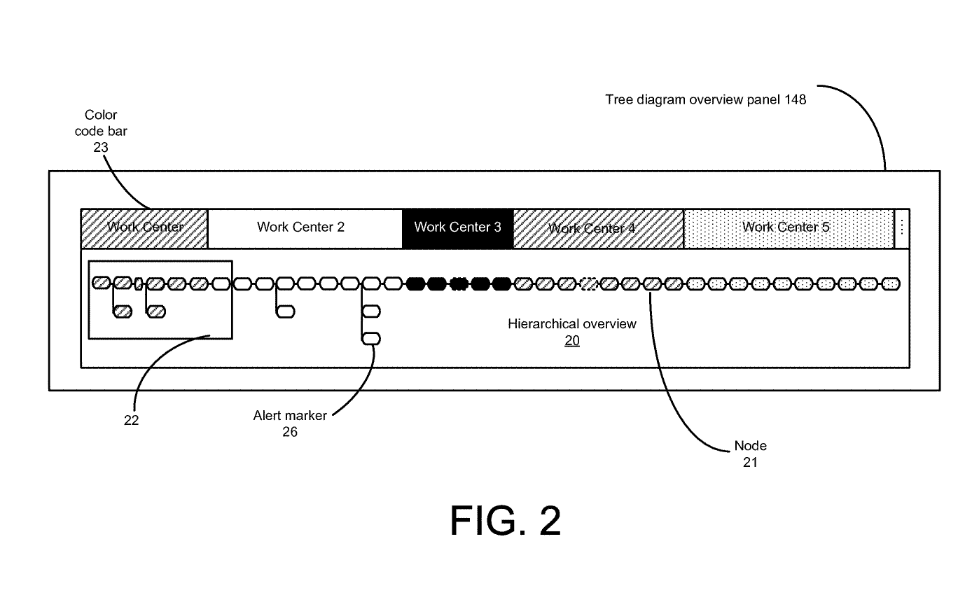

FIG. 2 shows an example overview (e.g., hierarchical tree structure overview 20) of the example automobile manufacturing process flow, which may be displayed by rendering engine 144 of system 100 in a single overview display panel (e.g., tree diagram overview panel 148) on UI 142, in accordance with the principles of the present disclosure.

Hierarchical tree structure overview 20 (displayed in tree diagram overview panel 148) on UI 142) may include a visual depiction of all (or substantially all) of the nodes of the tree diagram representation of the automobile manufacturing process flow. Icons, marks or pictures may be used to visually represent the nodes of the process flow in tree diagram overview panel 148. For the example shown in FIG. 2, oval cells are used to represent the nodes (e.g., node 21). Since the tree diagram representation of the automobile manufacturing process flow and the number of nodes displayed may be large, there may not be sufficient clear space in tree diagram overview panel 148 to include legible textual information describing each or all of the nodes.

However, a color coding scheme may be implemented to visually convey at least some information describing each or all of the nodes. In an example color coding scheme, the nodes (i.e. process steps and/or process work stations) may be color coded according to the work centers (e.g., Work Center 1, Work Center 2, etc.) to which the nodes belong. A color code bar or legend in tree diagram overview panel 148 may provide a visual key to help quick visual identification of which particular work center (e.g., Work Center 1, Work Center 2, etc.) a particular colored node belongs. FIG. 2 shows, for example, a color code bar 23 in which Work Centers 1-5 are keyed as corresponding to different colors (e.g. colors 1-5, respectively) and each node (e.g., node 21) is shown having the same color as the respective color of Work Centers 1-5 to which the node belongs. The color code bar (e.g., color code bar 23) or legend may include legible—size text, symbols or marks.

Other visual color or marking schemes may be used by rendering engine 144 to visually convey other or additional information. For example, an alert marker 26 (e.g., a red color, or a bold line (as shown in the figure), blinking colors, etc.) may be used highlight and draw visual attention to a current “alert” status of certain nodes (e.g., nodes that correspond to work stations or process steps that may currently have a process-related alert status). The other or additional information may be conveyed using legible—size text, symbols or marks.

It will be understood that rendering engine 144 may dynamically update hierarchical tree structure overview 20 in real time or near real time so that any information (e.g., alert marker 26) conveyed by the visual representation of hierarchical tree structure overview 20 is timely and relevant to the viewer.

In general, semantically meaningful colors and markings may be used to identify the cells representing nodes of a hierarchical structure in the overview panel. The semantically meaningful colors and markings may be used to communicate information regarding the nodes of the hierarchical structure. In the case where the hierarchical structure represents a process flow, the semantically meaningful colors may, for example, indicate which nodes are associated with which work centers of the process flow, identify categories of nodes, identify alerts and/or unassigned operations, and highlight root cause analysis and/or errors, etc.

All nodes and hierarchical levels of a large hierarchical structure may be visually depicted in the overview display panel. The overview display panel may be a non-scrollable condensed hierarchy structure overview. In the overview display panel, each node in the hierarchy may be depicted, for example, by a colored cell. The colored cell may have only color with no or little text associated with. The colored cell can be shrunk to any size (e.g., to a minimum pixel(s) size of a computer screen compatible with human visual resolution) and still remain visible on the overview display panel. Allowing the colored cell to be shrinkable to any size may enable the entire or complete hierarchical structure to be shrunk to fit in the overview display panel. Depending on the size of the hierarchical structure, the colored cell size may be expanded or shrunk to show the entire hierarchical structure in the overview display panel. The overview display panel may be presented in combination with other views, for example, a scrollable multi-page magnified or expanded view, of the large hierarchical structure or process flow. In the magnified or expanded view, the colored cell size may equal or exceed a legible-text size.

In example implementations of system 100, rendering engine 144 may include user-activable UI control elements (e.g., links, filters, area selectors, etc.) in the single overview display panel (e.g., tree diagram overview panel 148) on UI 142. The user-activable UI control elements may be configured to enable viewers to drill down hierarchical tree structure overview 20 to view detailed information on portions or fragments (e.g., individual nodes, groups of nodes, hierarchy levels, etc.) of the tree diagram representation of the automobile manufacturing process flow. FIG. 2 shows, for example, a slideable window 22, which can be slideably controlled by a viewer to select a group of enclosed nodes for drill down. Further, each node (e.g., node 21) as shown in the figure may, for example, be represented by a point-and-click or a hover-over control UI element amenable to user selection (for drill down).

Additional or detailed information on the portions or fragments of the tree diagram representation (e.g., nodes or group of nodes) of hierarchical tree structure overview 20, which are selected for drill down, may be displayed by rendering engine 144 as views (e.g., in pop-up windows or display panels) other than, and in addition to, hierarchical tree structure overview 20 displayed in tree diagram overview panel 148. The additional or detailed information may be displayed using legible—size text, symbols or marks in the views.

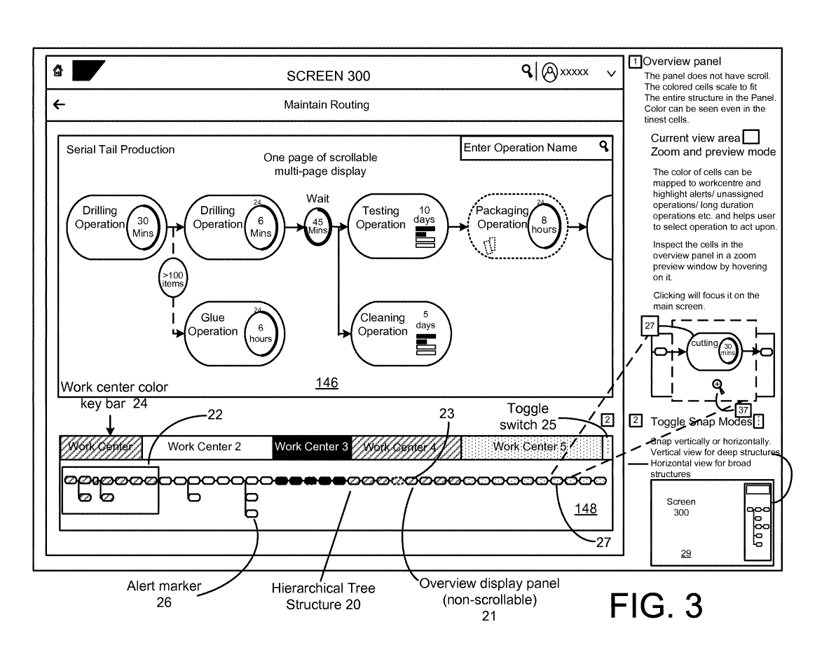

FIG. 3 shows an example computer screen 300 which includes hierarchical tree structure overview 20 displayed in a single tree diagram overview panel 148 (as in FIG. 2). Example computer screen 300 also includes a scrollable multi-page display panel 146. Each page of multi-page display 146 may show an exploded or expanded view of a selected portion of the tree diagram representation of the automobile manufacturing process flow. For example, as shown in the figure, the displayed page of multi-page display panel 146 may correspond to the portion of the tree diagram enclosed by slideable window 22 in tree diagram overview panel 148. In example implementations, views in multi-page display panel 146 and tree diagram overview panel 148 may be coupled so that scrolling action (e.g., to the left or right) in multi-page display panel 146 is automatically causes similar movement of slideable window 22 in tree diagram overview panel 148. This feature may enable a viewer to visually identify, in one glance, the relation of the information presented in an instant view of the multi-page display panel 146 and the corresponding portion of the automobile manufacturing process flow. For example, a viewer may, at a glance, identify that the information presented in the instant view of multi-page display panel 146 shown, for example, in FIG. 3, corresponds to the nodes (e.g., the nodes of Work Center 1 and a first node of Work Center 2) that are enclosed by slideable window 22 in tree diagram overview panel 148.

Tree diagram overview panel 148 may be displayed on the computer user interface with control UI elements for additional display features (e.g., pop-up windows, hover preview window, etc.), which may be utilized by a user for interactive detailed analysis or investigation of the hierarchical structure. For example, a hover-over UI element (e.g., element 27) may be configured so that when a user hovers over a cell or node, a zoom preview window (e.g., pop-up window 37) may open up to show an expanded view of the cell or node. The zoom preview window (e.g., pop-up window 37) showing the expanded cell or node may include additional information (including textual information or other details) regarding the cell or node. Further, a “point-and-click” or “select” UI element (e.g., UI element 23) may be configured to overlap with the display of a cell or node (e.g., node 21) so that when a user clicks on cell or node 21 in tree diagram overview panel 148 the associated scrollable multi-page expanded view shown in multi-page display panel 146 automatically scrolls to display the portion of the tree diagram that includes the selected cell or node 21. At any time, tree diagram overview panel 148 may visually show (using slideable window 22) which portion of the hierarchy structure is being currently being displayed in multi-page display panel 146.

In FIGS. 2 and 3, hierarchical tree structure overview 20 is generally shown with most node-to-node process flows and tree diagram overview panel 148 generally oriented in a horizontal direction. However, in some cases, the hierarchies/flows in hierarchical tree structure overview 20 may be more vertical (deep) than horizontal (wide). For such instances, tree diagram overview panel 148 may be configured with a toggle switch (e.g., switch 25) which can reorient the display of tree diagram overview panel 148 to be in a vertical direction on the user interface or computer screen. Orienting tree diagram overview panel 148 in a vertical direction may allow use of the vertical height of screen 300 to get a complete view a deep hierarchical tree structure overview 20 (as shown in inset 29, FIG. 3).

In general, tree diagram overview panel 148 may use dynamic colored cells that can scale up and down in size and still be visible. This visibility characteristic of the dynamic colored cells used to represent nodes of hierarchical tree structure overview 20 may make it possible to showcase small or massive hierarchies/flows with focused information. Because of the size scalability of the dynamic colored cells, displays of the complete hierarchical structure 20 (or substantially large portions of thereof) may scale to fit into computer screen of various sizes (e.g., desktop, laptop, tablet, workstation, mobile phone computer screens, etc.). Semantic color coding of the cells may be used to convey information about the various portions/levels of hierarchical structure 20. For example, the cells/nodes of hierarchical structure 20 may be color coded to identify them according to portions of hierarchical structure 20 (e.g., using work centers color index bar 24) to which the cells/nodes belong.

Tree diagram overview panel 148, with nodes of hierarchical tree structure overview 20 represented by color cell elements, may be used as an effective tool by a user to inspect, analyze and jump to various portions/levels of large hierarchical structures with single click operations.

By displaying a complete hierarchical structure (or substantially large portions of thereof) in a single panel (e.g., tree diagram overview panel 148), the systems and methods described herein, make it possible for a user to explore or inspect hierarchy or flow elements without losing sight of the overall structure of hierarchical structure. Color codes and zoom preview may allow users to jump to a specific cell/node with a single click operation. The single click operations of tree diagram overview panel 148 may be easy to use compared to traditional search/filters options that are used to explore or inspect hierarchy or flow elements in traditional displays of a hierarchical structure.

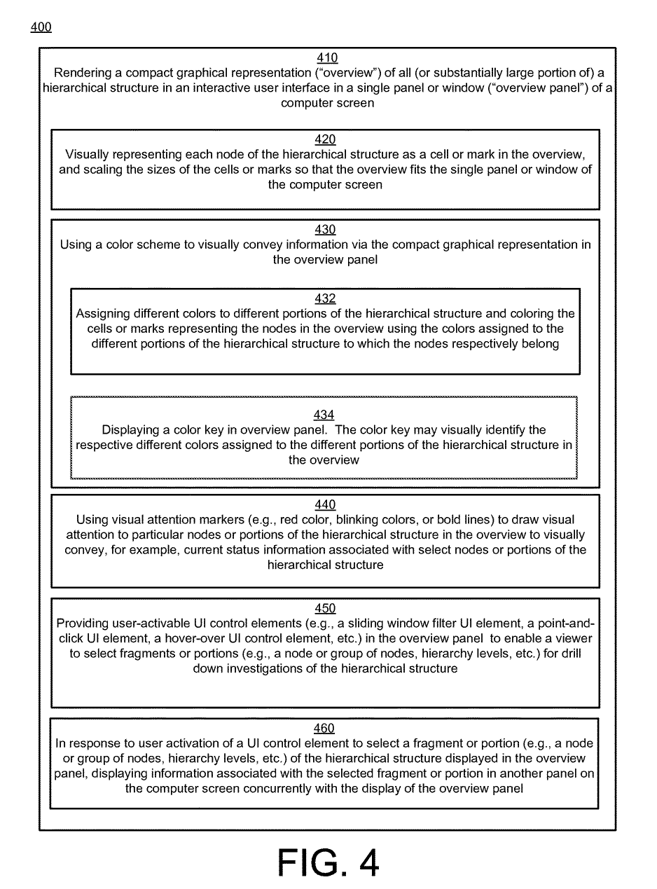

FIG. 4 shows an example method 400 for conveying information on a large tree diagram or a hierarchical structure to a viewer, in accordance with the principles of the present disclosure. The tree diagram or hierarchical structure may, for example, relate to a process flow of a business, organization, or industry. The tree diagram or hierarchical structure may have a large number of nodes and hierarchy levels.

Method 400 may include rendering a compact graphical representation (“overview”) of all (or substantially large portion of) the hierarchical structure in an interactive user interface in a single panel or window (“overview panel”) of a computer screen (410). Method 400 may involve visually representing each node of the hierarchical structure as a cell or mark in the overview, and scaling the sizes of the cells or marks so that the overview fits the single panel or window of the computer screen (420). The sizes to which the cells or marks can be scaled down to may be about 300 pixels per inch (PPI), which is about the limit beyond which the unaided human eye generally cannot differentiate detail.

Method 400 may include using a color scheme to visually convey information via the compact graphical representation of the hierarchical structure in the overview panel (430). In an example implementation, a color scheme may assign different colors to different portions of the hierarchical structure. Method 400 may involve coloring the cells or marks representing the nodes in the overview using the colors assigned to the different portions of the hierarchical structure to which the nodes respectively belong (432). Method 400 may also involve displaying a color key in overview panel (434). The color key may visually identify the respective different colors assigned to the different portions of the hierarchical structure in the overview. Method 400 may further include using visual attention markers (e.g., red color, blinking colors, or bold lines) to draw visual attention to particular nodes or portions of the hierarchical structure in the overview. The visual attention markers may, for example, visually convey status information associated with select nodes or portions of the hierarchical structure (440).

Method 400 may also involve providing user-activable UI control elements (e.g., a sliding window filter UI element, a point-and-click UI element, a hover-over UI control element, etc.) in the overview panel (450). The user-activable UI control elements may be configured to enable a viewer to select fragments or portions (e.g., a node or group of nodes, hierarchy levels, etc.), for example, for drill down investigations of the hierarchical structure.

Method 400 may involve, in response to user activation of a UI control element to select a fragment or portion (e.g., a node or group of nodes, hierarchy levels, etc.) of the hierarchical structure displayed in the overview panel, displaying information associated with the selected fragment or portion in another panel or window on the computer screen concurrently with the display of the overview panel (460). In an example implementation, sliding window filter UI element may be used to delineate and select a portion (including one or more nodes) of the hierarchical structure displayed in the overview panel, and method 400 may include displaying an exploded or expanded view of the selected portion of the hierarchical structure as a page in a scrollable multi-page display panel concurrently or simultaneously with the display of the overview of the hierarchical structure in the overview panel.

The various systems and techniques described herein may be implemented in digital electronic circuitry, or in computer hardware, firmware, or in combinations of them. The various techniques may implemented via a computer program product, i.e., a computer program with instructions tangibly embodied in a machine readable storage device, for execution by, or to control the operation of, data processing apparatus, e.g., a programmable processor, a computer, or multiple computers.

Method steps may be performed by one or more programmable processors executing a computer program to perform functions by operating on input data and generating output. Method steps also may be performed by, and an apparatus may be implemented as, logic circuitry or special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magnetooptical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a backend component, e.g., as a data server, or that includes a middleware component, e.g., an application server, or that includes a frontend component, e.g., a client computer having a graphical user interface or a Web browser through which a user can interact with an implementation, or any combination of such backend, middleware, or frontend components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method comprising:
rendering a graphical overview representing all of a hierarchical structure in a single overview display panel on a computer screen,
wherein each node of the hierarchical structure is visually represented as a cell in the graphical overview; and
when the graphical overview is larger in size than the single overview display panel, scaling down the sizes of the cells so that the graphical overview representation of all of the hierarchical structure fits in the single overview display panel on the computer screen.

2. The method of claim 1 further comprising using a color scheme to visually convey information via the graphical overview representation in the single overview display panel of the computer screen.

3. The method of claim 2, wherein using the color scheme includes assigning different colors to different portions of the hierarchical structure and coloring the cells representing the nodes in the overview representation using the colors assigned to the different portions of the hierarchical structure to which the nodes respectively belong.

4. The method of claim 3, further comprising displaying a color key in overview display panel, the color key identifying the respective different colors assigned to the different portions of the hierarchical structure.

5. The method of claim 3, further comprising using visual attention markers to draw visual attention to particular nodes of the hierarchical structure in the overview representation.

6. The method of claim 5, wherein using the visual attention markers includes visually conveying status information associated with select nodes of the hierarchical structure.

7. The method of claim 1, further comprising providing user-activable UI control elements in the single overview display panel on the computer screen to enable a viewer to select fragments of the hierarchical structure.

8. The method of claim 7, further comprising, in response to user activation of a UI control element to select a fragment of the hierarchical structure, displaying information associated with the selected fragment in another panel on the computer screen concurrently with the display of the graphical overview representation in the single overview display panel.

9. The method of claim 8, wherein the UI control element is a sliding window used to delineate and select the fragment of the hierarchical structure, and wherein the displaying information associated with the selected fragment in another panel on the computer screen includes displaying an exploded view of the selected fragment of the hierarchical structure as a page in a scrollable multi-page display panel concurrently with the display of the single overview display panel.

10. The method of claim 8, wherein the selected fragment is a node of the hierarchical structure, and wherein the displaying information associated with the selected fragment in another panel on the computer screen comprises displaying information associated with the selected node in a pop-up window on the computer screen.

11. A computer system comprising:
a memory;
a semiconductor-based processor; and
a rendering engine configured to:
render a graphical overview representing all of a hierarchical structure in a single overview display panel on a computer screen,
wherein each node of the hierarchical structure is visually represented as a cell in the graphical overview; and
when the graphical overview is larger in size than the single overview display panel, scale down the sizes of the cells so that the graphical overview representation of all of the hierarchical structure fits in the single overview display panel of the computer screen.

12. The computer system of claim 11, wherein the rendering engine is configured to implement a color scheme to visually convey information via the graphical overview representation in the single overview display panel of the computer screen.

13. The computer system of claim 11, wherein the rendering engine is configured to assign different colors to different portions of the hierarchical structure and color the cells representing the nodes in the overview representation using the respective colors assigned to the different portions of the hierarchical structure to which the nodes respectively belong.

14. The computer system of claim 13, wherein the rendering engine is configured to display a color key in the overview display panel, the color key identifying the respective different colors assigned to the different portions of the hierarchical structure.

15. The computer system of claim 13, wherein the rendering engine is configured to use visual attention markers to draw visual attention to particular nodes of the hierarchical structure in the overview representation.

16. The computer system of claim 15, wherein the rendering engine is configured to use the visual attention markers to visually convey status information associated with select nodes of the hierarchical structure.

17. The computer system of claim 13, wherein the rendering engine is configured to provide user-activable UI control elements in the single overview display panel of the computer screen to enable a viewer to select fragments of the hierarchical structure.

18. The computer system of claim 17, wherein the rendering engine is configured to, in response to user activation of a UI control element to select a fragment of the hierarchical structure, display information associated with the selected fragment in another panel on the computer screen concurrently with the display of the single overview display panel.

19. The computer system of claim 18, wherein the UI control element is a sliding window used to enclose and select the fragment of the hierarchical structure, and wherein the rendering engine is configured to display an exploded view of the selected fragment of the hierarchical structure as a page in a scrollable multi-page display panel concurrently with the display of the single overview display panel.

20. The computer system of claim 18, wherein the selected fragment is a node of the hierarchical structure, and wherein the rendering engine is configured to display information associated with the selected node in a window on the computer screen.
